(19) United States
(12) Patent Application Publication
(10) Pub. No.: US 2016/0363692 A1
(43) Pub. Date: Dec. 15, 2016

(54) OPTICAL LIVESTOCK COUNTING SYSTEM AND METHOD

(71) Applicant: Ace/Avant Concrete Construction Co., Inc., Archdale, NC (US)

(72) Inventors: William G. Arpin, Archdale, NC (US); Jonathan L. Matson, Archdale, NC (US); Tracy L. Matson, Archdale, NC (US); David W. Somero, Archdale, NC (US)

(21) Appl. No.: 15/179,667

(22) Filed: Jun. 10, 2016

Related U.S. Application Data
(60) Provisional application No. 62/173,930, filed on Jun. 10, 2015.

(51) Int. Cl. G01V 8/12; G06M 1/272; A01K 29/00

(52) U.S. Cl. CPC G01V 8/12; A01K 29/00; G06M 1/272

(57) ABSTRACT

An optical livestock counting system includes a sensor mounted to establish a light curtain through an area where livestock are to at least one of pass and be contained, and a control unit operatively coupled with the sensor to detect the livestock within the light curtain and, when the livestock meet a predefined criteria, increment a count of the livestock.

### CROSS-REFERENCE TO RELATED APPLICATIONS

This application claims priority under 35 U.S.C. §119(e) to U.S. Provisional Patent Application Ser. No. 62/173,930 filed on Jun. 10, 2015, and incorporated herein by reference.

### FIELD OF THE INVENTION

The present invention relates generally to an optical livestock counting system and method and, more specifically, to non-invasively detecting and counting livestock, for example, for slaughter.

### BACKGROUND OF THE INVENTION

Livestock estimates provide the U.S. Department of Agriculture (USDA) and the livestock industry with basic data to project future meat supplies and producer prices. These estimates include, for example, the number of head slaughtered plus live and dressed weights for cattle, calves, hogs, and sheep, as well as the number of head slaughtered for goats, equine, and bison. Agricultural economists in both the public and private sectors use this information in economic analysis and research.

As noted by the National Agricultural Statistics Service (NASS) of the USDA (http://nass.usda.gov/Surveys/Guide_to_NASS_Surveys/Livestock_Slaughter/index.asp), livestock slaughter data are collected from nearly 800 federally inspected plants and over 2,000 plants under state inspection, with over 95 percent of the total U.S. slaughter for most species being under federal inspection. Slaughter data from federally inspected plants are important to the Food and Safety and Inspection Service in fulfilling its responsibilities mandated by the Federal Meat Inspection Act (21 USC 620 and 661), and data from federally and non-federally inspected slaughter plants are used to estimate total meat production. To derive such data, daily counts are compiled and submitted by each slaughter facility to contribute to monthly and annual totals released by the USDA, with federally inspected data being summarized weekly and accumulated to a monthly total for monthly release, and non-federally inspected data being summarized monthly.

Current methods of counting livestock at slaughter facilities (when the animals are still alive) typically include manual counting by a human as the animals pass by. Such manual counting is both monotonous and susceptible to human error for many reasons. For example, the sounds of the animals, the movement of the animals, and the sheer number of animals (in some instances several tens of thousands of animals per day) are just some of the reasons why someone could possibly lose count of how many animals have passed by them as the animals enter and/or are moved throughout the facility. This poses a problem for several reasons including providing proper payment to the farms providing the facility with the animals, as well as providing the weekly/monthly/annual counts needed by the USDA.

### BRIEF DESCRIPTION OF THE DRAWINGS

FIG. 1 illustrates one embodiment of an optical livestock counting system and method.

FIG. 2 illustrates another embodiment of an optical livestock counting system and method.

FIGS. 3A, 3B, 3C illustrate another embodiment of an optical livestock counting system and method.

FIGS. 4A, 4B, 4C illustrate one embodiment of a field of view of the optical livestock counting system and method of FIGS. 3A, 3B, 3C.

FIG. 5 is a flow chart schematically illustrating one embodiment of an optical livestock counting method.

FIG. 6 schematically illustrates one embodiment of an optical livestock counting system.

FIGS. 7 and 8 illustrate one embodiment of an interface of an optical livestock counting system.

### DETAILED DESCRIPTION

The concept being presented is a system and method for counting living livestock including, for example, cows, cattle, calves, heifers, steers, bulls, swine, hogs, pigs, sheep, lambs, goats, horses, ponies, mules, burros, donkeys, bison, chickens, turkeys, ducks, geese, quail, and other animals. More specifically, the system and method described herein provides for counting of livestock in preparation for slaughter or counting of living livestock for other reasons, such as counting of livestock prior or post shipment, transport or movement to or from various locations, facilities, or other defined areas. The system and method described herein may be used to more accurately count livestock in an effort to replace or double-check current human-based livestock counting, and may be used where non-invasive counting is desired. An example of where non-invasive counting is desired is when identifying tags or other devices (e.g., RFID tags), that may be affixed to or implanted in animals, cannot be affixed to or implanted in the animals for concern that the identifying tags or other devices may potentially get into the meat of the slaughtered animals and consumed by a human.

In one embodiment, the optical livestock counting system and method incorporates one or more laser sensors/scanners, such as one or more time-of-flight (TOF) laser sensors/scanners or one or more phase shift laser sensors/scanners, and a control unit with which other components (the laser sensor(s)/scanner(s), power supply, communication devices, etc.) are operatively and/or communicatively coupled so as to operate as a livestock counting system. The control unit may include a memory and a processor, with associated hardware and/or machine readable instructions (including firmware and/or software) embodied on a computer readable medium, for implementing and/or executing computer-readable, computer-executable instructions for data processing functions and/or functionality of the system and method. As such, and as described below, the system and method uses laser sensor(s)/scanner(s), such as time-of-flight (TOF) laser sensor(s)/scanner(s) or phase shift laser sensor(s)/scanner(s), and associated hardware and software to automatically detect and count the number of livestock passing through a control point or contained within a control area. In one embodiment, as described below, in detecting and counting the number of livestock, the system and method filters out humans within or passing through a light shield or light curtain created by the laser sensor(s)/scanner(s).

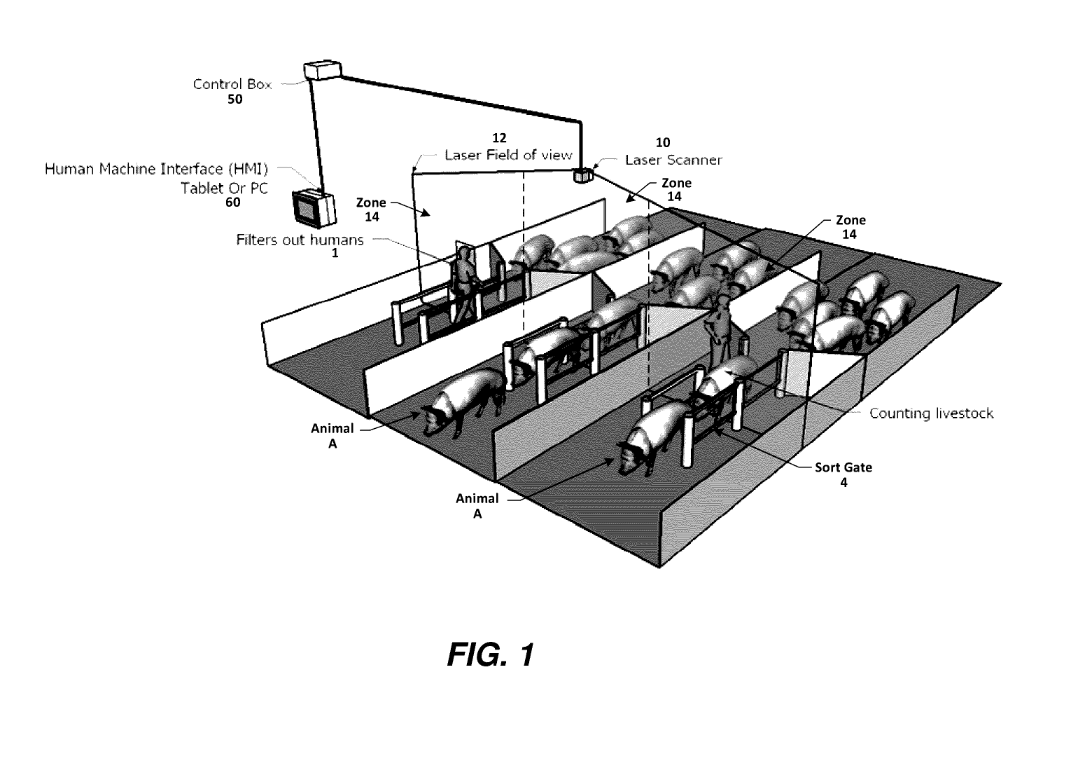

In one embodiment, one or more laser sensors/scanners 10, such as one or more time-of-flight (TOF) laser sensors/scanners (Lidar) or one or more phase shift laser sensors/scanners, are mounted above and/or to the side of where animals A will be passing under or next to (FIG. 1). In another embodiment, one or more laser sensors/scanners 10, such as one or more time-of-flight (TOF) laser sensors/scanners

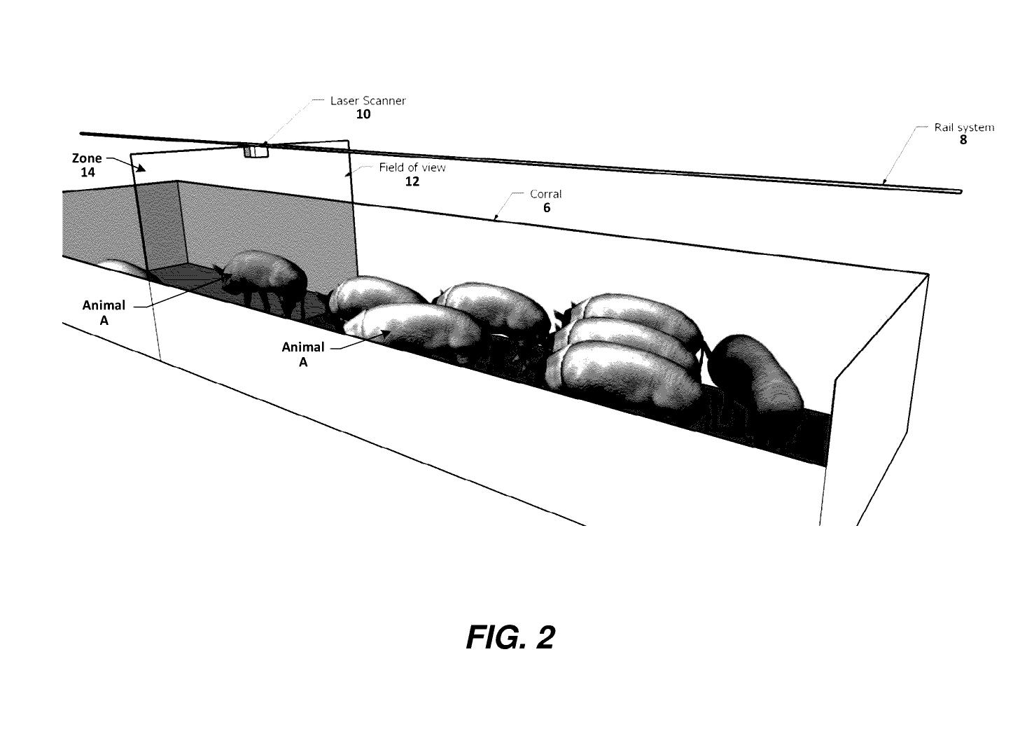

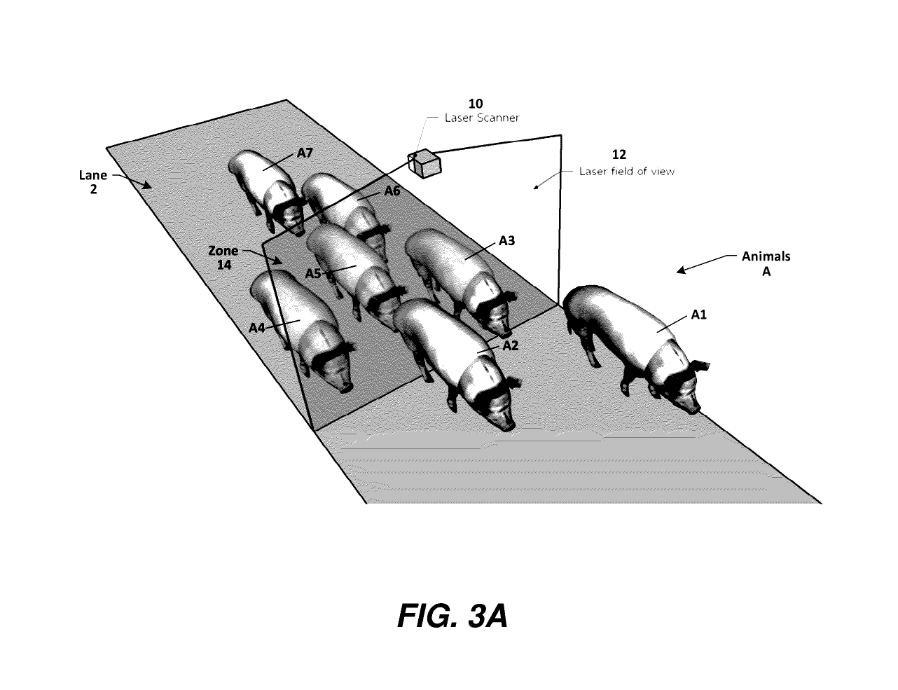

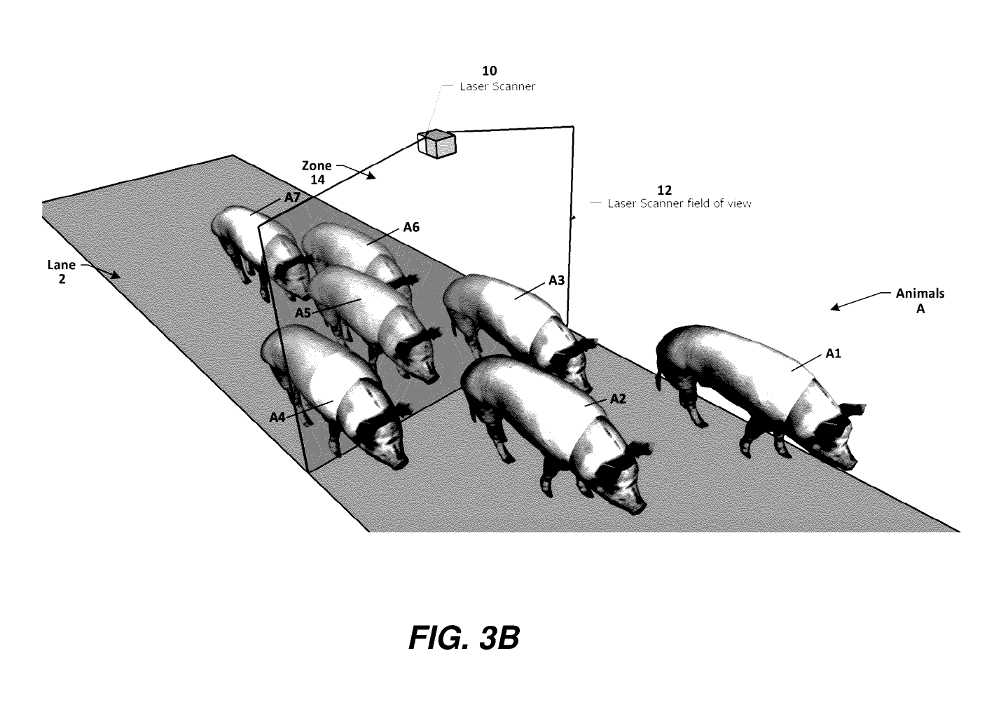

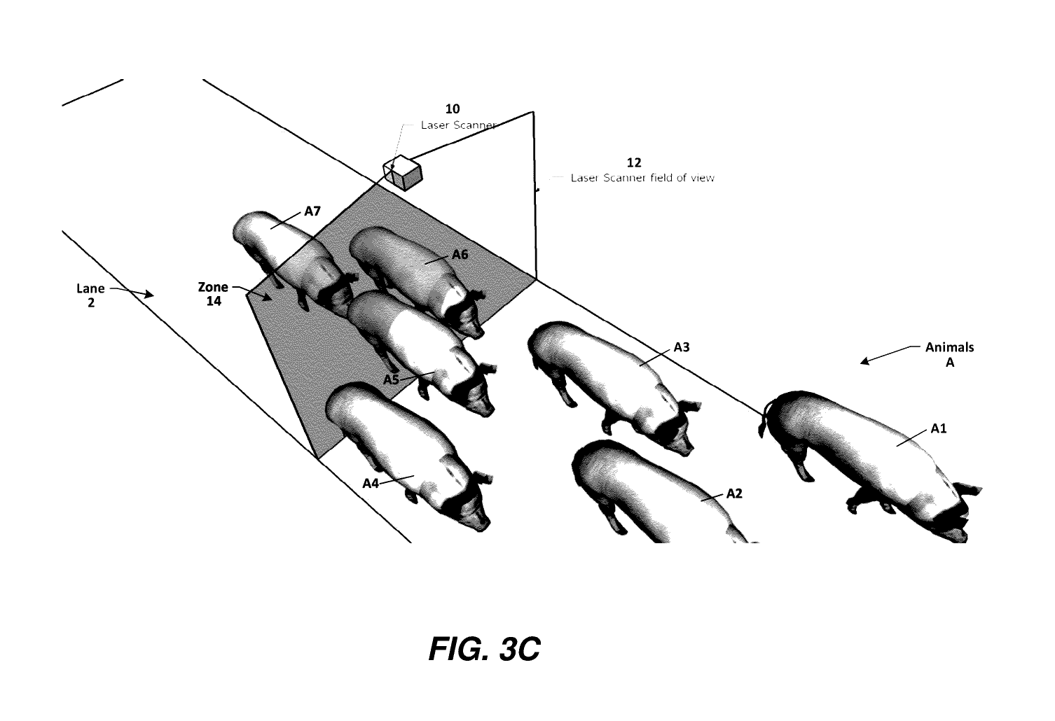

(Lidar) or one or more phase shift laser sensors/scanners, are mounted, for example, on a rail system 8 such that the laser sensor(s)/scanner(s) pass overhead of where animals A will be contained or corralled (FIG. 2). In another embodiment, one or more laser sensors/scanners 10, such as one or more time-of-flight (TOF) laser sensors/scanners (Lidar) or one or more phase shift laser sensors/scanners, are mounted above and/or to the side of where animals A will be passing under or next to (FIGS. 3A, 3B, 3C). In the embodiments, the laser sensor(s)/scanner(s) 10 have a laser field of view 12 and create or establish an invisible light shield or light curtain (e.g., class-1 infra-red eye safe light shield or light curtain) used to detect the animals A and trigger an event, such as a count or counting of an animal A or animals A, as described below. In one implementation, the invisible light shield or light curtain includes a vertical light shield or light curtain (FIGS. 1 and 2 and 3A, 3B, 3C) established through an area or areas where an animal A or animals A will be passing under or by, or where an animal A or animals A will be contained or corralled. Exemplary time-of-flight (TOF) laser sensor(s)/scanner(s) useable within the system and method described herein include LMS and TiM laser scanners by Sick AG. Exemplary phase shift laser sensor(s)/scanner(s) useable within the system and method described herein include LMS 400 laser scanners by Sick AG.

In addition to functioning as a detection device, the laser sensor(s)/scanner(s) 10 also function as a measurement device. As a measurement device, the laser sensor(s)/scanner(s) 10 may trigger an event, such as counting, only when an object within a field of view meets a predefined criteria. Accordingly, certain objects, such as humans 1 (see, e.g., FIG. 1), which may cause false positives, may be filtered out, as described below.

In one embodiment, the invisible light shield of the laser sensor(s)/scanner(s) create a measurement “curtain” within which a specific zone or zones may be defined. As such, each zone may have specific criteria (i.e., its own criteria) based on, for example, the size and/or time of an object (e.g., animal or person) in that zone. More specifically, in one example, each zone may have a size discrimination such that an object (e.g., person) detected above a certain height (e.g., above the height of the average pig) or detected for less than a certain amount of time (e.g., less than the amount of time the average cow is detected in a zone) will not trigger an event and will not generate a count, as described below. The laser sensor(s)/scanner(s), therefore, may be used to create an “intelligent” zone or zones. In one embodiment, multiple zones may be linked together (e.g., with PLC logic) to create a further zone or zones.

With the laser sensor(s)/scanner(s) described herein, a size and/or configuration of the invisible light shield or light curtain may be customized to create the specific zone or zones. In one embodiment, with the laser sensor(s)/scanner(s) mounted above where animals will be passing under, individual zones of the laser field of view may be sized and/or configured to extend through different areas or control points where animals pass. For example, as illustrated in the embodiment of FIG. 1, multiple zones 14 may be created to extend through separate chutes or sort gates 4 through which animals A pass (e.g., individually or single-file). As such, the laser sensor(s)/scanner(s) 10 detect and generate a count of an animal A as each animal A passes through a respective chute or sort gate 4. In addition, as a measurement device, the laser sensor(s)/scanner(s) may determine a size, speed, and/or direction of travel of the animal. In one embodiment, the laser sensor(s)/scanner(s) may also be used to automate and trigger or initiate a branding or labeling device to mark an animal as the animal passes, for example, through a respective chute, sort gate, or other control point. While three zones are illustrated, it is understood that any number of zones (i.e., one or more) and/or any configuration of zones may be established.

In one embodiment, with the laser sensor(s)/scanner(s) mounted to pass or scan overhead of where animals will be contained or corralled, a zone or zones of the laser field of view may be sized and/or configured to cover a dimension of an area within which the animals are contained or corralled. For example, as illustrated in the embodiment of FIG. 2, a zone 14 may be created to span a full width of a pen or corral (e.g., staging or control area) 6 where the animals A are contained or corralled, and the laser sensor(s)/scanner(s) 10 may pass or scan overhead of the animals A from one end of the pen or corral 6 to an opposite end of the pen or corral 6. As such, the laser sensor(s)/scanner(s) 10 detect and generate a count of animals A in the pen or corral 6.

In one implementation, the “count” of animals in the pen or corral is based on a volume measurement of the animals. For example, with a known size of the pen or corral (e.g., length, width), and a known size of an average animal (e.g., average size of a pig to be slaughtered), a measurement of the occupied space and/or a measurement of the remainder or free space (non-occupied space) may be used to determine a number (i.e., count) of animals in the pen or corral. As animals for slaughter are often of (substantially) uniform size, such measurement may be useful for densely packed animals, for example, chickens or turkeys.

In one embodiment, with the laser sensor(s)/scanner(s) mounted above where animals will be passing under, a zone or zones of the laser field of view may be sized and/or configured to cover a dimension of an area or control point where animals pass. For example, as illustrated in the embodiment of FIGS. 3A, 3B, 3C, a zone 14 may be created to span a full width of a chute or lane 2 through which animals A pass. As such, the laser sensor(s)/scanner(s) 10 detect and generate a count of an animal A as each animal A passes through the chute or lane 2.

In one implementation, and as described above, the laser sensor(s)/scanner(s) functions as a measurement device. As a measurement device, the laser sensor(s)/scanner(s) may trigger an event, such as counting, only when an object within a field of view meets a predefined criteria. For example, the laser sensor(s)/scanner(s) may trigger an event, such as counting, only when the size and/or time of an object within the field of view meets predefined criteria. More specifically, in one example, the laser sensor(s)/scanner(s) may trigger an event, such as counting, only when an object within the field of view meets a predefined size (e.g., exceeds a certain height and/or exceeds a certain width) and is within the field of view for a predefined time.

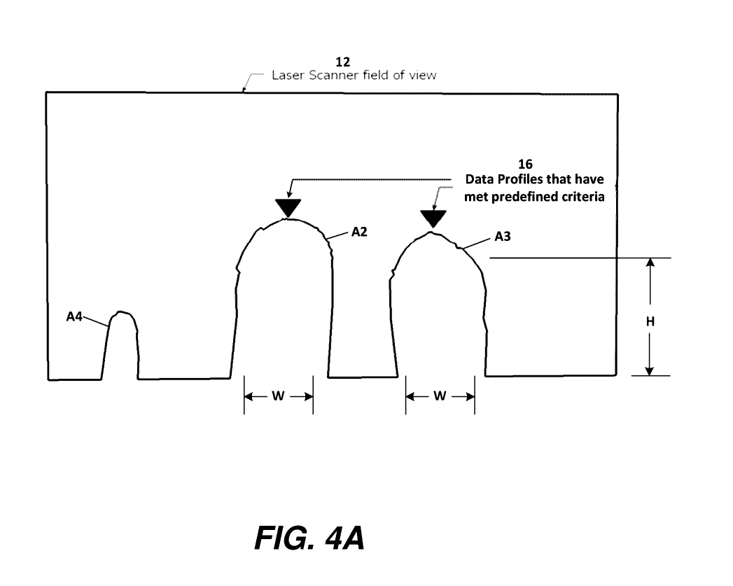

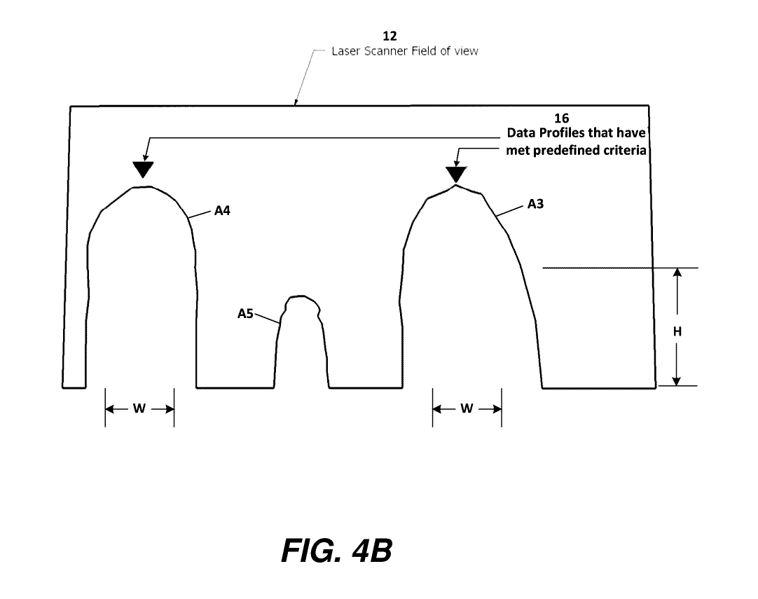

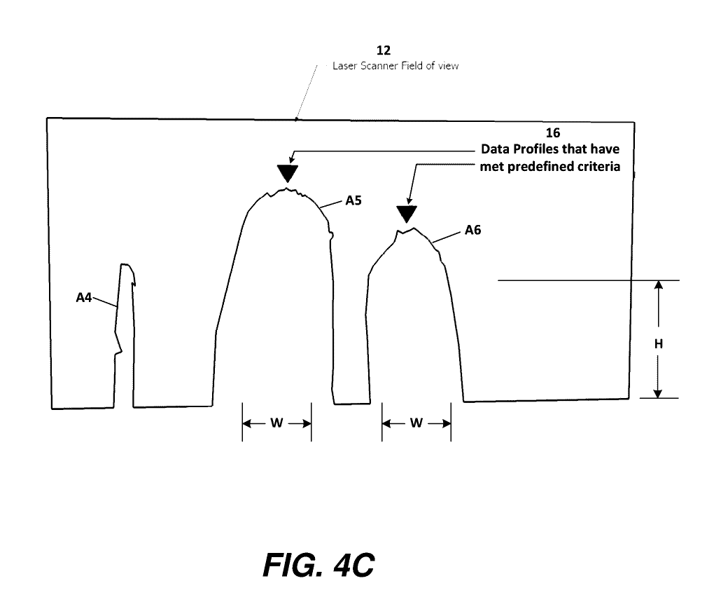

As an example, FIGS. 4A, 4B, 4C illustrate one embodiment of a field of view of the embodiment of FIGS. 3A, 3B, 3C. In the embodiment of FIGS. 3A, 3B, 3C, seven animals, identified as A1, A2, A3, A4, A5, A6, A7, are illustrated as passing through a chute or lane 2. As such, FIGS. 4A, 4B, 4C illustrate a field of view 12 of the laser sensor(s)/scanner(s) 10 corresponding to respective FIGS. 3A, 3B, 3C, with animals A passing through the field of view 12.

For example, FIG. 4A illustrates a field of view 12 of the laser sensor(s)/scanner(s) 10 corresponding to FIG. 3A, where animals A2 and A3 are detected as meeting a predefined criteria, namely, exceeding height H and width W, as indicated by data profiles 16. Animal A4 has entered the field of view (e.g., snout is detected), but has not yet met the predefined criteria. (Animal A1 has already passed through the field of view and, having met the predefined criteria, has been counted.)

Continuing the example, FIG. 4B illustrates a field of view 12 of the laser sensor(s)/scanner(s) 10 corresponding to FIG. 3B, where animals A3 and A4 are detected as meeting a predefined criteria, namely, exceeding height H and width W, as indicated by data profiles 16. Animal AS has entered the field of view, but has not yet met the predefined criteria. (Animals Al and A2 have already passed through the field of view and, having met the predefined criteria, have both been counted.)

Continuing the example, FIG. 4C illustrates a field of view 12 of the laser sensor(s)/scanner(s) 10 corresponding to FIG. 3C, where animals A5 and A6 are detected as meeting a predefined criteria, namely, exceeding height H and width W, as indicated by data profiles 16. Animal A4 is exiting the field of view (e.g., tail is detected), and having met the predefined criteria, namely, exceeding height H and width W for a predefined time, is counted. (Animals A1, A2, and A3 have already passed through the field of view and, having met the predefined criteria, have all been counted.)

In one implementation, for example, with the embodiment of FIGS. 3A, 3B, 3C and the corresponding field of views of FIGS. 4A, 4B, 4C, if an animal stops within the field of view of the laser sensor(s)/scanner(s), the system “holds” count of the animal until the animal moves and passes through the field of view, such that only one count is associated with the animal.

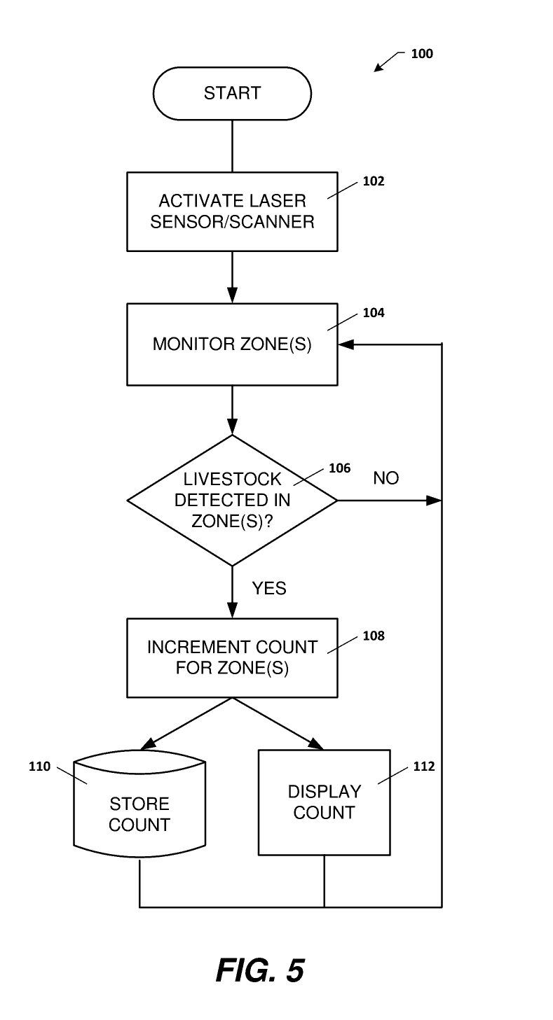

One example of a method 100 of optically counting livestock (or other animals) is schematically illustrated in FIG. 5. With the laser sensor(s)/scanner(s) activated, at 102, the zone or zones are monitored, at 104. In one example, as illustrated in FIG. 1, an object (e.g., animal A, human 1) is detected when the object enters the field of view 12 of the laser sensor(s)/scanner(s) 10. In one implementation, criteria, such as a size and/or time of an object in a zone, may be used to discriminate the object and filter objects (e.g., humans) that are to be excluded from the count. Thus, if the object is livestock (i.e., meets the criteria), as determined at 106, a count for the respective zone or zones is incremented, at 108. As such, the count may be stored, at 110, for example, for further compilation or manipulation, and/or displayed, at 112, for real-time output.

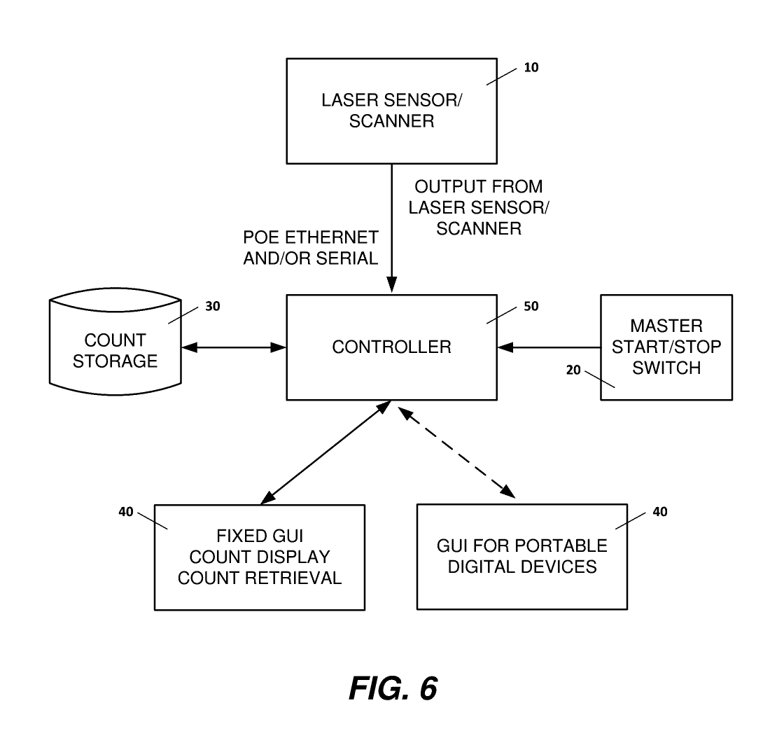

FIG. 6 schematically illustrates one embodiment of an optical livestock counting system. In one example, components of the system include one or more laser sensors/scanners 10 (as described above), a master start/stop switch 20, a count storage database 30, one or more interfaces (e.g., display or graphical user interfaces) 40, a control unit or controller 50 with which the other components of the system are operatively and/or communicatively coupled, and associated hardware, firmware, and/or software. The laser sensor(s)/scanner(s) 10 may be hardwired or wirelessly communicated with the controller 50. For example, the laser sensor(s)/scanner(s) 10 may be PoE (Power over Ethernet) or serially connected laser sensor(s)/scanner(s) 10, such that output of the laser sensor(s)/scanner(s) 10 is provided to the controller 50. In one example, the controller 50 is operatively and/or communicatively coupled with the laser sensor(s)/scanner(s) 10 to provide for input to or configuration of the laser sensor(s)/scanner(s) 10 with, for example, a computing device (e.g., HMI, PC, tablet, portable device) 60 (see, e.g., FIG. 1).

As described above, the laser sensor/scanner provides a “triggering” device for detecting an animal, for example, when the animal passes through the field of view or light “curtain” of the laser sensor/scanner or when the field of view or light “curtain” of the laser sensor/scanner passes over the animal, such that the detection is communicated to the controller to generate a “count” of the animal. In one example, as described above, the controller discriminates or filters the detection to confirm that the detection is in fact an animal. Data of the count may be recorded, for example, in the count storage database, compiled, or manipulated, and emailed, texted or otherwise displayed or distributed to or via a Human Machine Interface (HMI) or PC (positioned, for example, at a counting station), a portable or handheld device (e.g., phone, tablet), or other computing or electronic device.

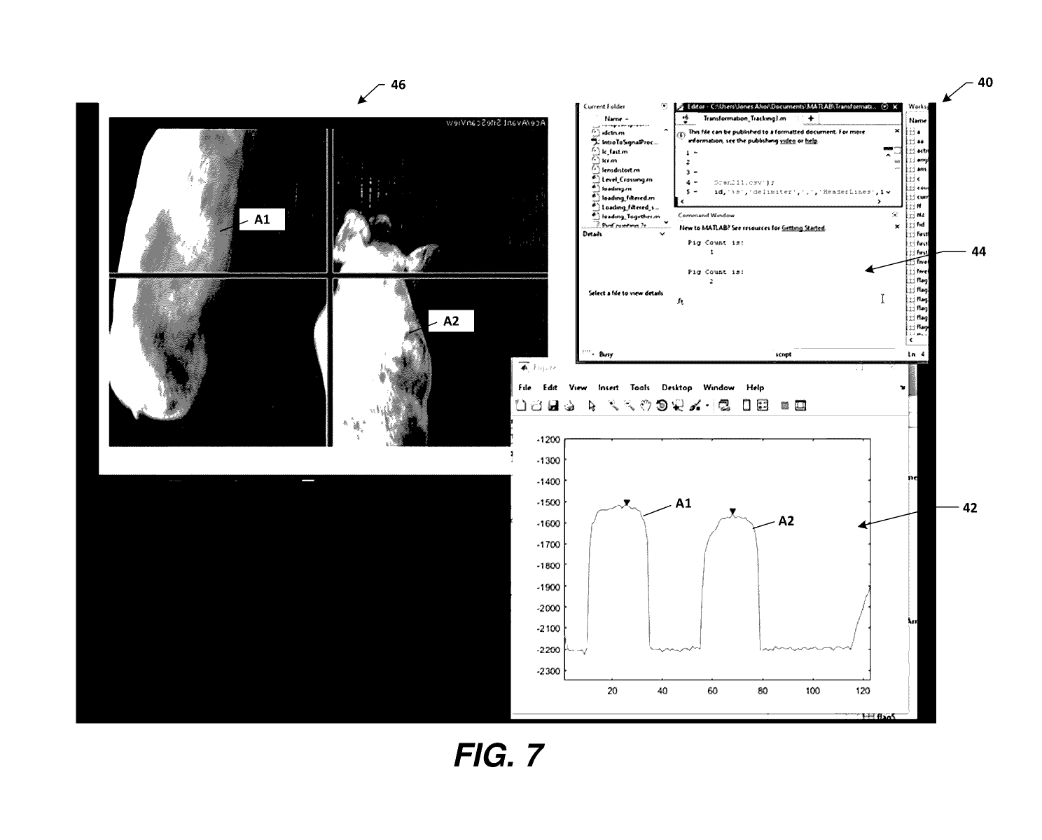

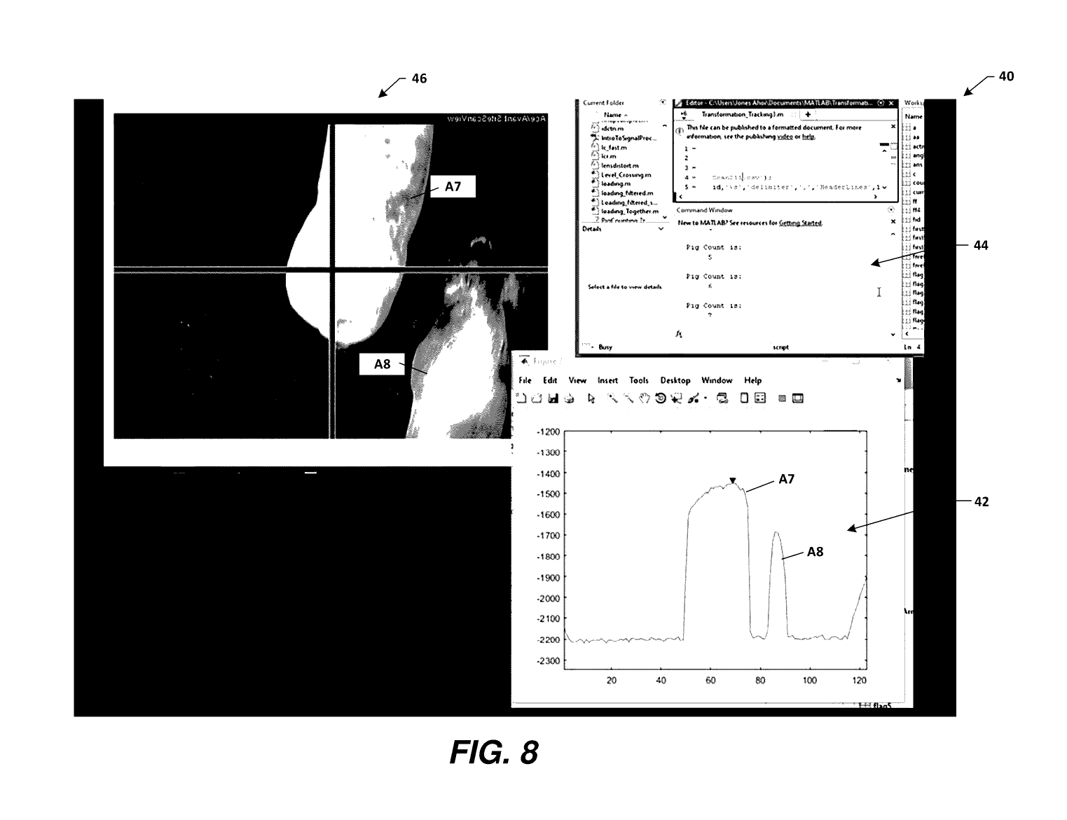

In one implementation, as illustrated in the example of FIGS. 7 and 8, the interface 40 displays a field of view of the laser sensor(s)/scanner(s), for example at 42, and displays count information of the animals, for example at 44. In one implementation, for example at 46, the interface 40 also displays an image (e.g., video) from a perspective of the laser sensor(s)/scanner(s) (e.g., from above) as animals pass through the field of view. For example, as illustrated in FIG. 7, at 42, the interface 40 displays the field of view of the laser sensor(s)/scanner(s) as detecting animals A1 and A2, at 44, the interface 40 displays count information as of counting animals A1 and A2 (i.e., “Pig Count is: 1”, “Pig Count is: 2”), and, at 46, the interface 40 displays an image (e.g., video) from a perspective of the laser sensor(s)/scanner(s) (e.g., from above) as animals A1 and A2 pass through the field of view. In addition, as illustrated in FIG. 8, at 42, the interface 40 displays the field of view of the laser sensor(s)/scanner(s) as detecting animals A7 and A8, at 44, the interface 40 displays count information as of counting animal A7 (i.e., “Pig Count is: 7”) (six animals have already passed through the field of view and have been counted, and animal A8 has entered the field of view, but has not yet being counted), and, at 46, the interface 40 displays an image (e.g., video) from a perspective of the laser sensor(s)/scanner(s) (e.g., from above) as animal A7 passes through the field of view and animal A8 enters the field of view. With the optical livestock counting system and method disclosed herein, the laser sensor/scanner provides a non-invasive, and more reliable and accurate counting of animals. For example, in the instance of a slaughter facility, a non-invasive pre-slaughter count as determined herein allows, for example, for a more accurate comparison count between how many animals were offloaded/delivered and how many animals are to be actually slaughtered. With the optical livestock counting system and method disclosed herein, such count can be generated and compiled in real-time to provide on-demand counts as well as hourly/daily/weekly/monthly/yearly counts. In addition, in the instance that the system is deployed during transport of livestock from a farm to the slaughter facility (e.g., loading/unloading of animals onto or from a truck or other vehicle, delivery of animals to or from a livestock auction market), the optical livestock counting system and method disclosed herein allows for a more accurate count of animals and the ability to associate a unique lot number with a particular group of animals to track the animals and the count during transport or movement. While described for use in detecting and counting livestock for slaughter, the optical livestock counting system and method disclosed herein may be used in detecting and counting livestock for other purposes, for example, providing or tracking a count of livestock on a farm or ranch, or at another location.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. An optical livestock counting system, comprising:
a sensor mounted to establish a light curtain through an area where livestock are to at least one of pass and be contained; and
a control unit operatively coupled with the sensor to detect the livestock within the light curtain and, when the livestock meet a predefined criteria, increment a count of the livestock.

2. The system of claim 1, wherein the sensor comprises a laser scanner.

3. The system of claim 1, wherein the sensor is mounted above where the livestock are to at least one of pass and be contained.

4. The system of claim 1, wherein the light curtain comprises an invisible light curtain.

5. The system of claim 1, wherein the light curtain comprises a vertical light curtain.

6. The system of claim 1, wherein the predefined criteria comprises at least one of size and time.

7. The system of claim 1, the sensor to determine a size of the livestock within a zone of the light curtain.

8. The system of claim 1, the sensor to determine a time of the livestock within a zone of the light curtain.

9. The system of claim 1, the control unit to measure a size of an object with the light curtain, and filter out the object within or passing through the light curtain when the object does not meet the predefined criteria.

10. The system of claim 9, wherein the object comprises a human.

11. The system of claim 1, further comprising:
an interface including at least one of display of a field of view of the sensor, display of count information of the livestock, and display of an image of the livestock within the field of view.

12. An optical livestock counting method, comprising:
establishing a light curtain with a sensor through an area where livestock are to at least one of pass and be contained;
detecting the livestock within the light curtain;
determining whether the livestock meet a predefined criteria; and
in response to the detecting the livestock and the livestock meeting the predefined criteria, incrementing a count of the livestock.

13. The method of claim 12, wherein the sensor comprises a laser scanner.

14. The method of claim 12, wherein the light curtain comprises a vertical light curtain.

15. The method of claim 12, wherein the predefined criteria comprises at least one of size and time.

16. The method of claim 12, wherein determining whether the livestock meet the predefined criteria comprises measuring a size of the livestock with the sensor.

17. The method of claim 12, wherein determining whether the livestock meet the predefined criteria comprises measuring, with the sensor, a time of the livestock within the light curtain.

18. The method of claim 12, further comprising:
measuring, with the light curtain, a size of an object within or passing through the light curtain;
determining that the object does not meet the predefined criteria; and
excluding the object from the count of the livestock.

19. The method of claim 12, wherein the object comprises a human.

20. The method of claim 12, further comprising:
displaying, with an interface, at least one of a field of view of the sensor, count information of the livestock, and an image of the livestock within the field of view.
